(19) United States
(12) Patent Application Publication
(10) Pub. No.: US 2014/0350974 A1
(43) Pub. Date: Nov. 27, 2014

(54) ROLL-CALL PROCESSING SYSTEM AND METHOD

(71) Applicant: Hon Hai Precision Industry Co., Ltd., New Taipei (TW)

(72) Inventors: JEN-HUNG LO, New Taipei (TW); EN-SHIH LIN, New Taipei (TW); PANG-HAO LIU, New Taipei (TW); MENG-LUNG SHEN, New Taipei (TW); CHUNG-YING YU, New Taipei (TW)

(73) Assignee: Hon Hai Precision Industry Co., Ltd., New Taipei (TW)

(21) Appl. No.: 14/093,028

(22) Filed: Nov. 28, 2013

(30) Foreign Application Priority Data
May 23, 2013 (TW) 102118222

(51) Int. Cl. G06Q 10/02; G06Q 50/20

(52) U.S. Cl. CPC G06Q 10/02; G06Q 50/205
USPC 705/5

(57) ABSTRACT

A roll-call processing method is executed by a server. The method records first connection information of a first electronic device and transmits a roll-call interface to the first electronic device when the server receives a request for the roll-call interface from the first electronic device. The method further records second connection information of at least one second electronic device and receives a photo transmitted from the second electronic device. The method transmits the received photo of the second electronic device to the first electronic device to display the received photo on the roll-call interface of the first electronic device.

### BACKGROUND

1. Technical Field

Embodiments of the present disclosure relate to data processing technology, and more particularly to a roll-call processing system and method.

2. Description of related art

When a teacher takes roll-call in class, the teacher calls names of students according to a list (or a roll) and determines presence or absence of students according to whether the students answer the roll-call. However, it is inefficient for the teacher to call each student one-by-one.

### BRIEF DESCRIPTION OF THE DRAWINGS

FIG. 1 is a block diagram of one embodiment of a server comprising a roll-call processing system.

FIG. 2 is a block diagram of one embodiment of function modules of the roll-call processing system in FIG. 1.

FIG. 3 is a flowchart of one embodiment of a roll-call processing method.

FIG. 4 is a schematic diagram illustrating one embodiment of a roll-call interface.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

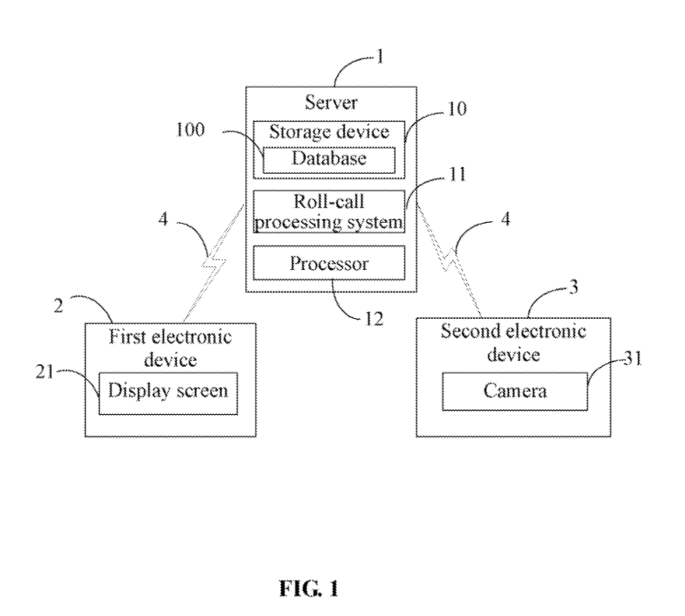

FIG. 1 is a block diagram of one embodiment of a server 1 comprising a roll-call processing system 11. The server 1 is connected to at least one first electronic device 2 and one or more second electronic devices 3 (only one second electronic device 3 is shown in FIG. 1) through a wireless network 4. The wireless network 4 uses a short distance wireless communication technology, such as IEEE802.11b (WIFI) technology, for example.

In one embodiment, the first electronic device 2 is considered as a device for executing a roll-call operation. For example, the first electronic device 2 is carried by a teacher. The first electronic device 2 includes a touch screen 21 for displaying visual data of the first electronic device 2. Each of the second electronic device 3 is considered as a device for being named by the first electronic device 2. For example, the second electronic device 3 is carried by a student. Each of the second electronic devices 3 includes a camera 31 for capturing photos of the user of the each second electronic device 3.

In one embodiment, the server 1 provides a software application of the roll-call processing system 11 for the first electronic device 2 and the second electronic devices 3 to be downloaded. In other embodiments, the first electronic device 2 and the second electronic devices 3 access the roll-call processing system 11 in the server 1 through a browser and the wireless network 4.

The server 1 further includes a non-transitory storage device 10 and at least one processor 12. The storage device 10 is a dedicated memory, such as an EPROM, a hard disk driver (HDD), or flash memory. The storage device 10 includes a database 100 for storing registration information of the first electronic device 2 and the second electronic devices 3. The registration information includes an account name, a password, and other personal information. The database 100 further stores data of at least one roll-call interface pre-established by the server 1 for the first electronic device 2. The processor 12 executes one or more computerized codes and other applications for the server 1, to provide the functions of the roll-call processing system 11.

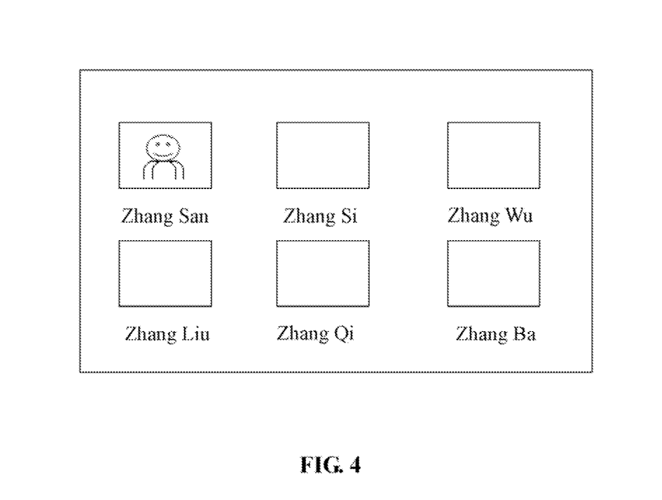

In one embodiment, the roll-call interface includes a plurality of photo fields and a name field corresponding to each of the photo fields. The photo fields may display photos of users of the second electronic devices 3 who are required to be named by the first electronic device 2. The photo fields are initially blank. The name fields store names of the users of the second electronic devices 3. The name fields are established according to the account names in the database 100 of the server 1. FIG. 4 is a schematic diagram illustrating one embodiment of the roll-call interface. In other embodiments, a distribution and an arrangement of the roll-call interface can be configured using the roll-call processing system 11 according to actual requirements. For example, a shape of the photo files can be elliptical.

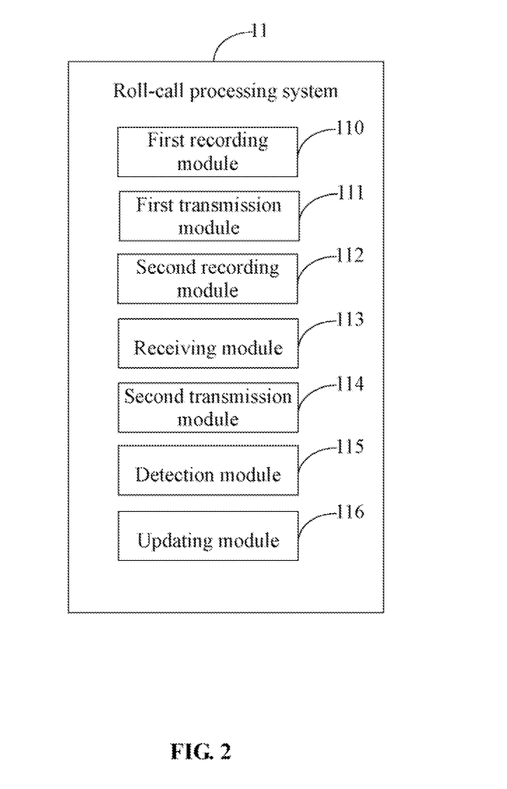

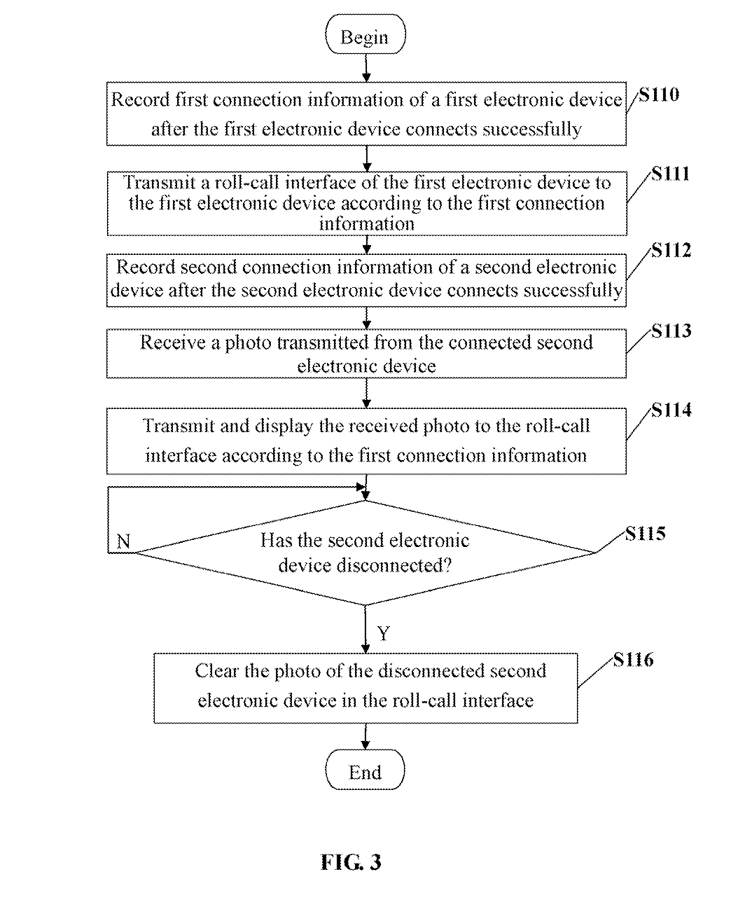

As shown in FIG. 2, the roll-call processing system 11 includes a plurality of function modules, such as a first recording module 110, a first transmission module 111, a second recording module 112, a receiving module 113, a second transmission module 114, a detection module 115, and an updating module 116. The modules 110-116 include computerized code in the form of one or more programs that are stored in a non-transitory storage device 10 of the server 1. The computerized code includes instructions that are executed by the at least one processor 12 of the server 1 to provide functions of the roll-call processing system 11. Detailed descriptions of the functions of the modules 110-116 are given below with reference to FIG. 3.

FIG. 3 is a flowchart of one embodiment of a roll-call processing method. Depending on the embodiment, additional steps may be added, others removed, and the ordering of the steps may be changed.

In step S110, when the first electronic device 2 is connected to the server 1 successfully, the first recording module 110 records first connection information of the first electronic device 2. The first connection information includes an account name and identification code of the first electronic device 2. The identification code represents an identifier, such as an Internet Protocol (IP) address, to identify the first electronic device 2. The server 1 transmits data to the first electronic device 2 according to the identification code of the first electronic device 2.

In one embodiment, the first electronic device 2 is connected to the server 1 by inputting an account name and a password through the wireless network 4. The first recording module 110 compares the input account name and the input password with the registration information stored in the database 10. If there is an account name the same as the input account name, and the input password matches a password corresponding to the account name, the first recording module 110 determines that the first electronic device 2 is connected to the server 1 successfully.

In step S111, when the server 1 receives a request for the roll-call interface from the first electronic device 2, the first transmission module 111 transmits the roll-call interface to the first electronic device 2 according to the first connection information. After the first electronic device 2 receives the roll-call interface, the display screen 21 of the first electronic device 2 displays the roll-call interface. In other embodiments, if there are a plurality of roll-call interfaces that can be provided for the first electronic device 2, the server 1 provides names of the roll-call interfaces to be selected by the first electronic device 2.

In step S112, when one second electronic device 3 is connected to the server 1 successfully, the second recording module 112 records second connection information of the second electronic device 3. The second connection information includes, but is not limited to, the account name of the second electronic device 3. When the second electronic device 3 is connected to the server 1 successfully, the second electronic device 3 captures a photo of the user of the second electronic device 3 using the camera 31, and transmits the photo to the server 1.

In step S113, the receiving module 113 receives the photo transmitted from the second electronic device 3 in real-time.

In step S114, the second transmission module 114 transmits the received photo to the first electronic device 2 to display the received photo on the roll-call interface of the first electronic device 2, according to the first connection information and the second connection information. In one embodiment, the second transmission module 114 traverses the name fields in the roll-call interface in sequence, and searches for a matched name field which has a same account name with the account name of the second electronic device 3. The second transmission module 114 transmits the received photo to the first electronic device 2 to display the received photo in the photo field corresponding to the matched name field. If there is no name field matching the account name of the second electronic device 3, the transmission module 114 transmits an error prompt to the second electronic device 3.

As shown in FIG. 4, a second electronic device 3 having an account name “12345” transmits the photo to the server 1. If a name field “Zhang San” corresponds to the account name “12345,” the photo of the second electronic device 3 is displayed in the photo field corresponding to the name field “Zhang San.” The first electronic device 2 can use the roll-call interface to finish the roll-call operation conveniently and accurately.

In step S115, the detection module 115 detects whether the second electronic device 3 is disconnected from the server 1 at a predetermined time interval (e.g. 2 minutes). If the second electronic device 3 is not disconnected from the server 1, step S115 is repeated. If the second electronic device 3 is disconnected from the server 1, step S116 is implemented. In one embodiment, if the detection module 115 receives a predetermined disconnection command (or a logout command) from the second electronic device 3, the detection module 115 determines that the second electronic device 3 is disconnected from the server 1.

In step S116, the updating module 116 updates the roll-call interface in the first electronic device 2 by deleting the photo of the corresponding disconnected second electronic device 3 from the roll-call interface.

In one embodiment, if the first electronic device 2 is disconnected from the server 1, the procedure of the roll-call is ended.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A roll-call processing method being executed by a processor of a server, the method comprising:
recording first connection information of a first electronic device;
transmitting a roll-call interface stored in the server to the first electronic device according the first connection information, in response to receiving a request for the roll-call interface from the first electronic device;
recording second connection information of a second electronic device;
receiving a photo transmitted from the second electronic device; and
displaying the received photo on the roll-call interface of the first electronic device, according to the first connection information and the second connection information.

2. The method of claim 1, further comprising:
detecting whether the second electronic device is disconnected from the server at a predetermined time interval;
updating the roll-call interface in the first electronic device by clearing the photo of the second electronic device in the roll-call interface when the second electronic device is disconnected from the server.

3. The method of claim 1, wherein the roll-call interface comprises a plurality of photo fields and a name field corresponding to each of the photo fields, the name fields storing user names of persons who require to be named by the first electronic device, and the name fields are established according to account names in a database of the server.

4. The method of claim 3, wherein the received photo is displayed on the roll-call interface by:
traversing the name fields in the roll-call interface, and searching for a matched name field which has a same account name with an account name of the second electronic device;
transmitting the received photo to the first electronic device to display the received photo on a photo field corresponding to the matched name field.

5. The method of claim 1, wherein the first connection information comprises an account name and an identification code of the first electronic device, and the second connection information comprises an account name of the second electronic device.

6. The method of claim 1, wherein the server is connected to the first electronic device and the second electronic device through a wireless network, which uses a short distance wireless communication technology.

7. A server, comprising:
at least one processor; and
a storage device storing one or more programs, when executed by the at least one processor, cause the at least one processor to perform operations of:
recording first connection information of a first electronic device;
transmitting a roll-call interface stored in the server to the first electronic device according the first connection information, in response to receiving a request for the roll-call interface from the first electronic device;
recording second connection information of a second electronic device;
receiving a photo transmitted from the second electronic device; and
displaying the received photo on the roll-call interface of the first electronic device, according to the first connection information and the second connection information.

8. The server of claim 7, wherein the operations further comprise:
detecting whether the second electronic device is disconnected from the server at a predetermined time interval;
updating the roll-call interface in the first electronic device by clearing the photo of the second electronic device in the roll-call interface when the second electronic device is disconnected from the server.

9. The server of claim 7, wherein the roll-call interface comprises a plurality of photo fields and a name field corresponding to each of the photo fields, the name fields storing user names of persons who require to be named by the first electronic device, and the name fields are established according to account names in a database of the server.

10. The server of claim 9, wherein the received photo is displayed on the roll-call interface by:
traversing the name fields in the roll-call interface, and searching for a matched name field which has a same account name with an account name of the second electronic device;
transmitting the received photo to the first electronic device to display the received photo on a photo field corresponding to the matched name field.

11. The server of claim 7, wherein the first connection information comprises an account name and an identification code of the first electronic device, and the second connection information comprises an account name of the second electronic device.

12. The server of claim 7, wherein the server is connected to the first electronic device and the second electronic device through a wireless network, which uses a short distance wireless communication technology.

13. A non-transitory computer-readable medium having stored thereon instructions that, when executed by at least one processor of a server, cause the at least one processor to perform operations of:
recording first connection information of a first electronic device;
transmitting a roll-call interface stored in the server to the first electronic device according the first connection information, in response to receiving a request for the roll-call interface from the first electronic device;
recording second connection information of a second electronic device;
receiving a photo transmitted from the second electronic device; and
displaying the received photo on the roll-call interface of the first electronic device, according to the first connection information and the second connection information.

14. The medium of claim 13, wherein the operations further comprise:
detecting whether the second electronic device is disconnected from the server at a predetermined time interval;
updating the roll-call interface in the first electronic device by clearing the photo of the second electronic device in the roll-call interface when the second electronic device is disconnected from the server.

15. The medium of claim 13, wherein the roll-call interface comprises a plurality of photo fields and a name field corresponding to each of the photo fields, the name fields storing user names of persons who require to be named by the first electronic device, and the name fields are established according to account names in a database of the server.

16. The medium of claim 15, wherein the received photo is displayed on the roll-call interface by:
traversing the name fields in the roll-call interface, and searching for a matched name field which has a same account name with an account name of the second electronic device;
transmitting the received photo to the first electronic device to display the received photo on a photo field corresponding to the matched name field.

17. The medium of claim 13, wherein the first connection information comprises an account name and an identification code of the first electronic device, and the second connection information comprises an account name of the second electronic device.

18. The medium of claim 13, wherein the server is connected to the first electronic device and the second electronic device through a wireless network, which uses a short distance wireless communication technology.
